(19) United States
(12) Patent Application Publication
(10) Pub. No.: US 2023/0305306 A1
(43) Pub. Date: Sep. 28, 2023

(54) BACKLIGHT UNIT FOR NEAR EYE DISPLAYS WITH CORNER PLACEMENT OF LIGHT EMITTING DIODES

(71) Applicant: Meta Platforms Technologies, LLC, Menlo Park, CA (US)

(72) Inventors: Li Zhuang, Bellevue, WA (US); Shenglin Ye, Santa Clara, CA (US); Kyung Won Park, Bellevue, WA (US); Agnes Lee, Saratoga, CA (US)

(21) Appl. No.: 18/120,860

(22) Filed: Mar. 13, 2023

Related U.S. Application Data
(60) Provisional application No. 63/322,789, filed on Mar. 23, 2022.

(51) Int. Cl. G02B 27/01

(52) U.S. Cl. CPC G02B 27/0172; G02B 2027/011; G02B 2027/0118; G02B 2027/0178

(57) ABSTRACT

A display device improves illumination uniformity and form factor for a backlight unit (BLU). The display device includes a display area having pixels and a BLU at a back side of the display area. The BLU is configured to direct light to the pixels. The BLU includes a diffusion plate with a top side, a bottom side, and a right side connecting the top side and the bottom side, and a left side at an opposite side of the right side and connecting the top side and the bottom side. The BLU includes light sources located at one or more of the left and right sides of the diffusion plate to emit light into the diffusion plate. The left and right sides may include slanted portions connecting center portions of the left and right sides to the top and bottom sides. Light sources may be located at the slanted portions.

### CROSS-REFERENCE TO RELATED APPLICATIONS

This application claims the benefit of U.S. Provisional Application No. 63/322,789, filed Mar. 23, 2022, which is incorporated by reference in its entirety.

### FIELD OF THE INVENTION

This disclosure relates generally to display devices, and more specifically to backlight units for illuminating pixels of display devices.

### BACKGROUND

Display devices can use backlight units to emit light into a display area for viewing media content. Backlight units in devices such as personal computers or display monitors use side firing lights. For example, a computer monitor may have LED strips at the top and bottom or left and right of the rectangular display area. Side firing lights can cause nonuniform light distribution across a display area. For example, placing side firing light strips with different numbers of light sources on either side creates a nonuniform light distribution. When the length of a side firing light strip is similar to the length of an existing display area at which the strip is positioned, the side firing lights may illuminate the display area without consuming unnecessary space. However, illuminating display areas of devices where the length of the existing display area is shorter than the light strip can cause the lights to inefficiently occupy additional space. This can be disadvantageous when size or weight constraints are critical. For similar reasons, side firing lights may limit the shape of a display device to have a length in one dimension (i.e., the dimension in which the strip is positioned) that is unnecessarily long. Thus, side firing lights can also restrict the shape of display devices.

### SUMMARY

A display device improves illumination uniformity and form factor for a backlight unit (BLU). The display device includes a display area having pixels and a BLU at a back side of the display area. The BLU is configured to direct light to the pixels. The BLU includes a diffusion plate with a top side, a bottom side, and a right side connecting the top side and the bottom side, and a left side at an opposite side of the right side and connecting the top side and the bottom side. The BLU includes light sources located at one or more of the left and right sides of the diffusion plate to emit light into the diffusion plate. The left and right sides may include slanted portions connecting center portions of the left and right sides to the top and bottom sides. Light sources may be located at the slanted portions.

In some embodiments, the right side has a center portion perpendicular to the top side or the bottom side. The right side may further include a first slanted portion connecting the center portion and the top side. A first subset of the light sources can be placed to emit light into the first slanted portion.

In some embodiments, the right side further has a second slanted portion connecting the center portion and the bottom side, where a second subset of the light sources is placed to emit light into the second slanted portion.

In some embodiments, the first subset of the light sources is oriented in two or more directions.

In some embodiments, the display device can further include a display driver IC (DDIC) located at a back side of the BLU, where the back side faces away from the display area (i.e., a direction away from the direction light is traveling to a user’s eyes).

In some embodiments, the display device can further include a BLU driver configured to modify an amount of light emitted by one or more light sources of the BLU.

In some embodiments, the positions of the one or more light sources are asymmetric about a line bisecting the diffusion plate.

In some embodiments, the light sources are light-emitting diodes (LEDs).

In some embodiments, the same number of light sources are located at the first slanted portion and the second slanted portion.

In some embodiments, the display area is included within a head mounted display (HMD).

Other aspects include components, devices, systems, improvements, methods, processes, applications, computer readable mediums, and other technologies related to any of the above.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 1C is a cross section of a front rigid body of the head-mounted display, in accordance with one or more embodiments.

FIG. 2A illustrates a block diagram of an electronic display environment, in accordance with one or more embodiments.

FIG. 2B illustrates a perspective diagram of the elements of a display device, in accordance with one or more embodiments.

FIG. 2C illustrates an example display device with a two-dimensional array of illumination elements or LC-based pixels, in accordance with one or more embodiments.

FIG. 3 shows a BLU having top and bottom strips of light sources, according to one or more embodiments.

FIG. 4 shows a BLU having slanted light sources, according to one or more embodiments.

FIG. 5 shows various local dimming configurations for light sources of a BLU, according to one or more embodiments.

FIG. 6 shows a back side of a BLU, according to one or more embodiments.

FIG. 7 shows a BLU having light sources oriented in varying directions, according to one or more embodiments.

FIG. 8 is a flowchart illustrating a process for configuring local dimming through a BLU, in accordance with one or more embodiments.

FIG. 9 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

In the following description of embodiments, numerous specific details are set forth in order to provide more thorough understanding. However, note that the embodiments may be practiced without one or more of these specific details. In other instances, features have not been described in detail to avoid unnecessarily complicating the description.

Embodiments relate to a display device with a backlight unit (BLU) that emits light at various locations around a surface area of a diffusion plate. In particular, light sources of the BLU are located at slanted portions of sides of the diffusion plate (e.g., corners of the diffusion plate). This may result in a greater backlight uniformity. Additionally, light sources of the BLU may be selectively dimmed using a driver that can modify the light intensity of a subset of the light sources. This may result in a local dimming capability that can improve contrast and reduce power consumption.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

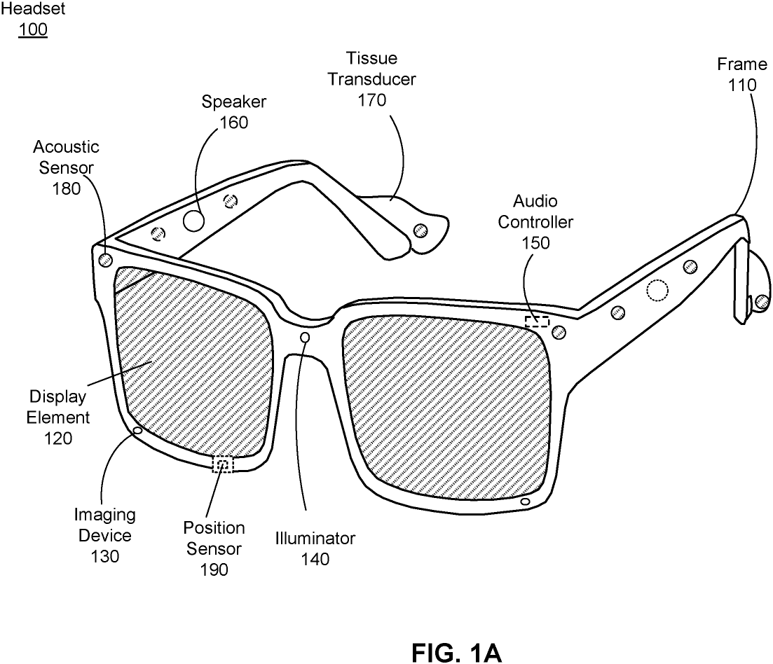

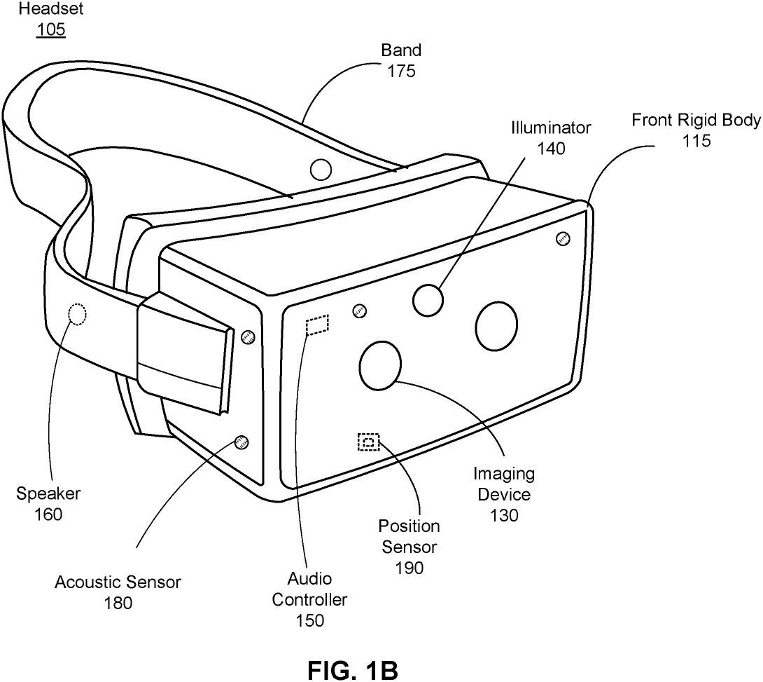

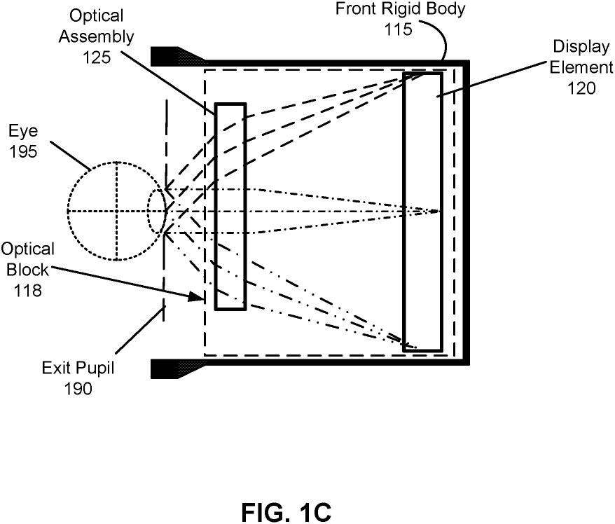

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user’s eyesight. In some embodiments, the display element 120 may be polarized and/or tinted to protect the user’s eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

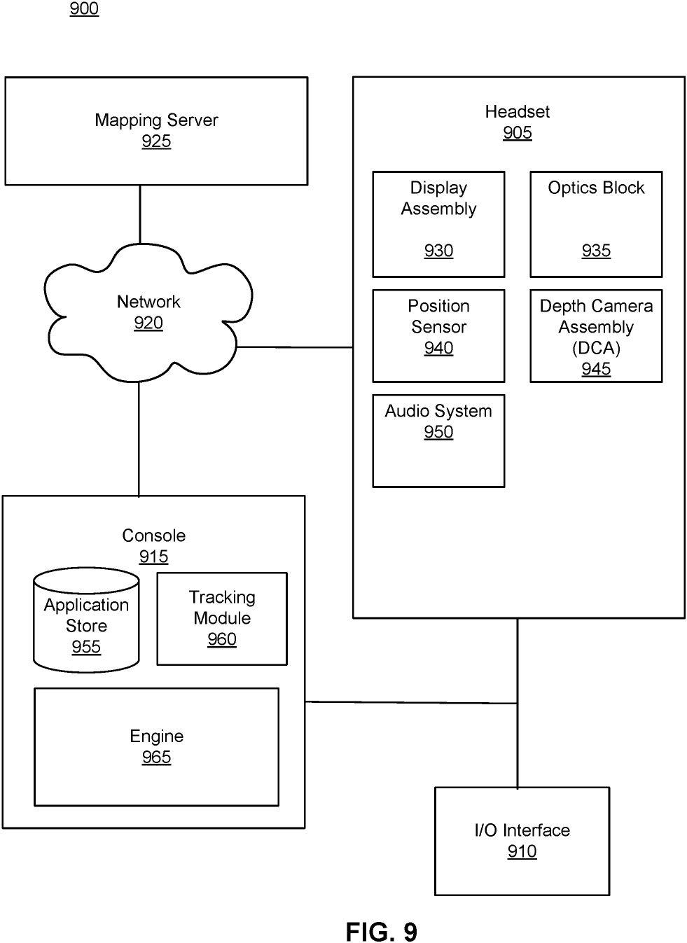

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 9.

FIG. 1B is a perspective view of a headset 105 implemented as a HMD, in accordance with one or more embodiments. In embodiments that describe an AR system and/or a MR system, portions of a front side of the HMD are at least partially transparent in the visible band (~380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to front rigid body 115, or may be configured to be inserted within the ear canal of a user.

FIG. 1C is a cross section of the front rigid body 115 of the head-mounted display shown in FIG. 1B. As shown in FIG. 1C, the front rigid body 115 includes an optical block 118 that provides altered image light to an exit pupil 190. The exit pupil 190 is the location of the front rigid body 115 where a user’s eye 195 is positioned. For purposes of illustration, FIG. 1C shows a cross section associated with a single eye 195, but another optical block, separate from the optical block 118, provides altered image light to another eye of the user.

The optical block 118 includes a display element 120 (also referred to as a display or a display device), and the optics block 125. The display element 120 emits image light toward the optics block 125. The optics block 125 magnifies the image light, and in some embodiments, also corrects for one or more additional optical errors (e.g., distortion, astigmatism, etc.). The optics block 125 directs the image light to the exit pupil 190 for presentation to the user.

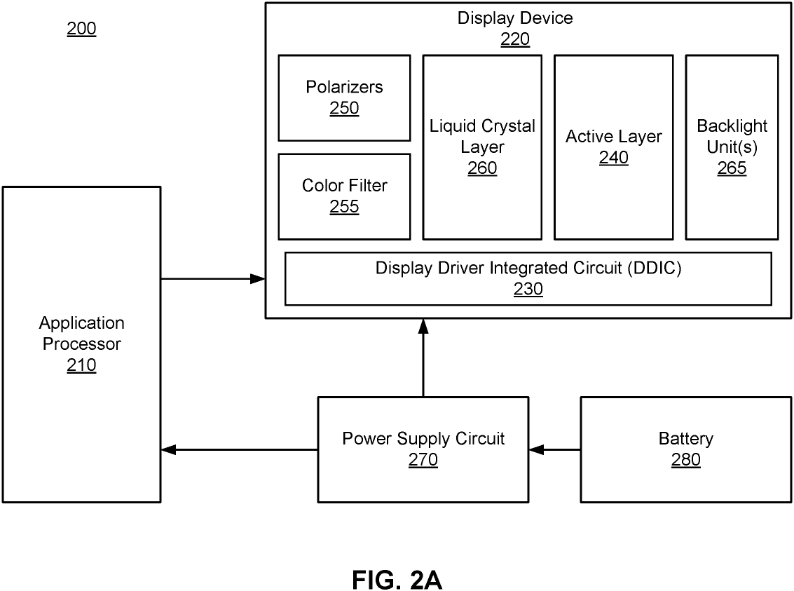

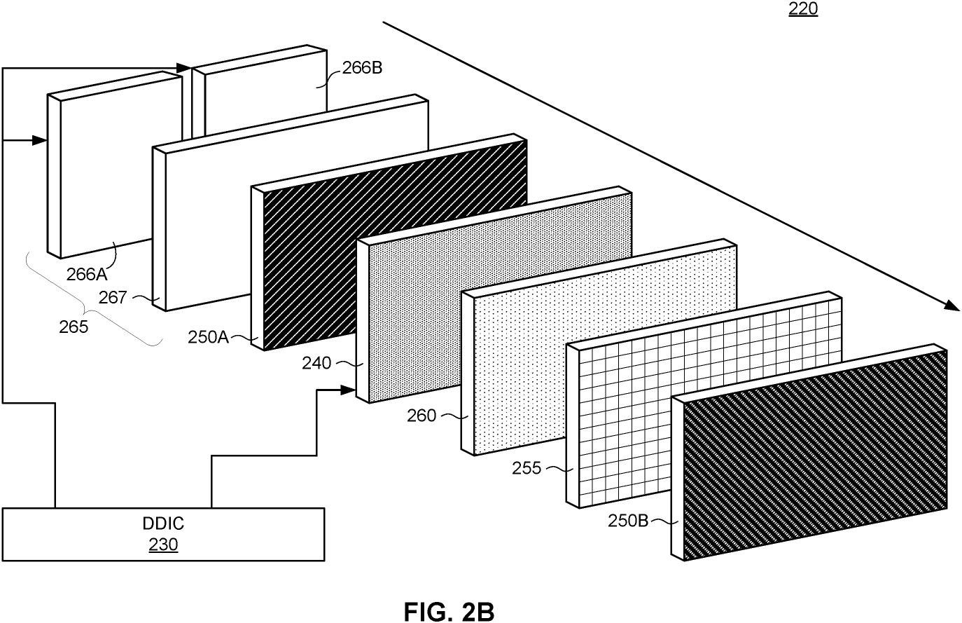

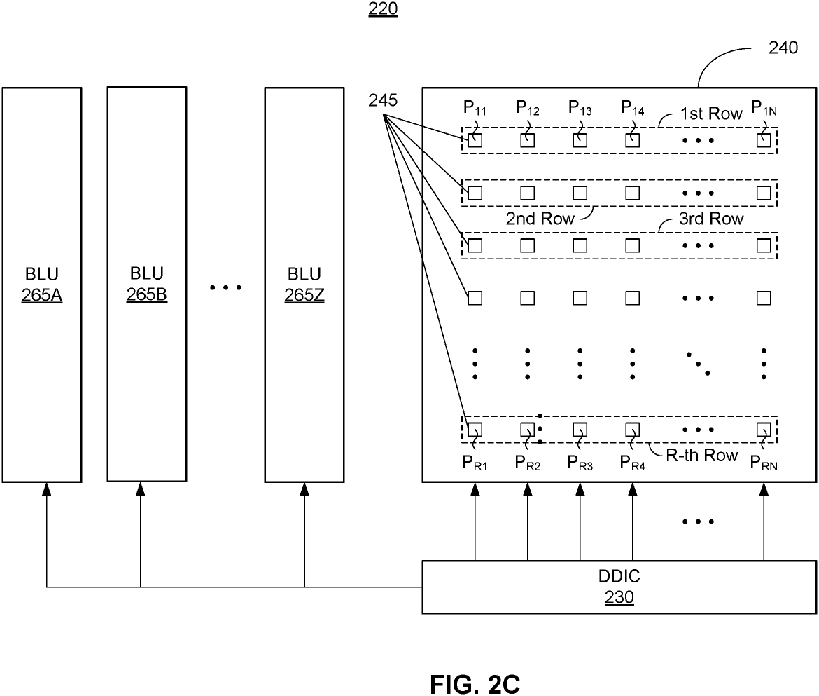

FIG. 2A illustrates a block diagram of an electronic display environment 200, in accordance with one or more embodiments. The electronic display environment 200 includes an application processor 210, and a display device 220. In some embodiments, the electronic display environment 200 additionally includes a power supply circuit 270 for providing electrical power to the application processor 210 and the display device 220. In some embodiments, the power supply circuit 270 receives electrical power from a battery 280. In other embodiments, the power supply circuit 270 receives power from an electrical outlet.

The application processor 210 generates display data for controlling the display device to display a desired image. The display data include multiple pixel data, each for controlling one pixel of the display device to emit light with a corresponding intensity. In some embodiments, each pixel data includes sub-pixel data corresponding to different colors (e.g., red, green, and blue). Moreover, in some embodiments, the application processor 210 generates display data for multiple display frames to display a video.

The display device 220 includes a display driver integrated circuit (DDIC) 230, an active layer 240, a liquid crystal (LC) layer 260, one or more backlight units 265, polarizers 250, and a color filter 255. The display device 220 may include additional elements, such as one or more additional sensors. The display device 220 may be part of the HMD 100 in FIG. 1A or FIG. 1B. That is, the display device 220 may be an embodiment of the display element 120 in FIG. 1A or FIG. 1C. FIG. 2B illustrates a perspective diagram of the elements of the display device 220, in accordance with one or more embodiments. A display area of the display device 220 may include the polarizers 250, the active layer 240, the LC layer 260, and the color filter 255. The one or more backlight units 265 may be located at a back side of the display area (i.e., at a side of the display area that is in a direction opposite to the direction in which light travels to a user’s eyes).

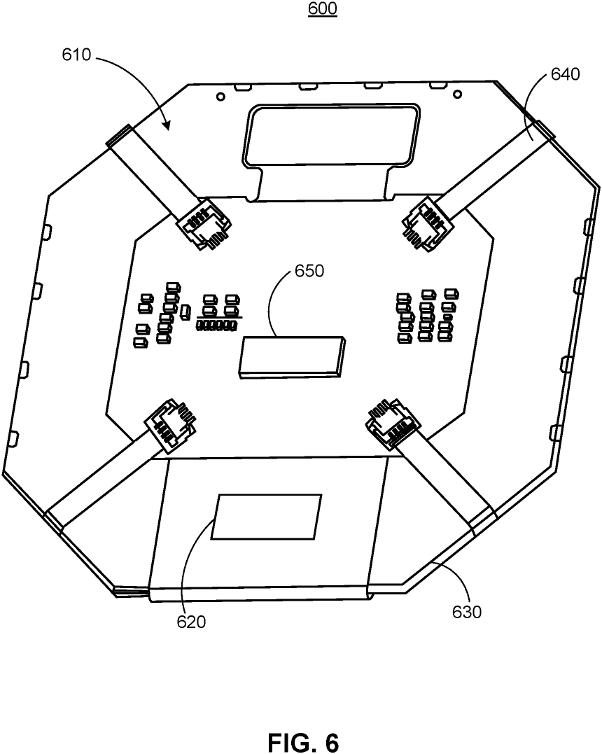

The DDIC 230 receives a display signal from the application processor 210 and generates control signals for controlling each pixel 245 in the active layer 240, and the one or more BLUs 265. In one example, the DDIC 230 generates signals to program each of the pixels 245 in the active layer 240 according to an image signal received from the application processor 210. Moreover, the DDIC 230 generates one or more signals to control one or more light sources of the one or more BLUs 265 (e.g., light sources 266A and 266B). In some embodiments, the display device 220 may include a driver separate from the DDIC 230 that additionally or alternatively controls the one or more light sources. One example of an LED driver is shown in FIG. 6.

The active layer 240 includes a set of pixels 245 organized in rows and columns. For example, the active layer 240 includes N pixels (P₁₁ through P_{1N}) in the first row, N pixels (P₂₁ through P_{2N}) in the second row, N pixels (P₃₁ through P_{3N}) in the third row, and so on. Each pixel includes sub-pixels, each corresponding to a different color. For example, each pixel includes red, green, and blue sub-pixels. In addition, each pixel may include white sub-pixels. Each sub-pixel may include a thin-film-transistor (TFT) for controlling the liquid crystal in the LC layer 260. For example, the TFT of each sub-pixel is used to control an electric field within a specific area of the LC layer to control the crystal orientation of the liquid crystal within the specific area if the LC layer 260.

The LC layer 260 includes a liquid crystal which has some properties between liquids and solid crystals. In particular, the liquid crystal has molecules that may be oriented in a crystal-like way. The crystal orientation of the molecules of the liquid crystal can be controlled or changed by applying an electric field across the liquid crystal. The liquid crystal may be controlled in different way by applying the electric field in different configurations. Schemes for controlling the liquid crystal includes twisted noematic (TN), in-plane switching (IPS), plane line switching (PLS), fringe field switching (FFS), vertical alignment (VA), etc.

Each pixel 245 is controlled to provide a light output that corresponds to the display signal received from the application processor 210. For instance, in the case of an LCD panel, the active layer 240 includes an array of liquid crystal cells with a controllable polarizations state that can be modified to control an amount of light that can pass through the cell.

The one or more BLUs 265 may be turned on at predetermined time periods to generate light that can pass through each of the liquid crystal cell to produce a picture for display by the display device. The one or more BLUs 265 include one or more light sources 266 (e.g., light sources 266A and 266B shown in FIG. 2B) and a diffusion plate 267. The embodiment of FIG. 2B depicts two light sources. However, any suitable alternative number of light sources may be included within a BLU. The one or more light sources 266 illuminate light towards the array of liquid crystal cells in the active layer 240 and the array of liquid crystal cells controls an amount and location of light passing through the active layer 240. The light from the one or more light sources is directed through the diffusion plate 267. Although not depicted, the diffusion plate 267 may include one or more diffusion films and a light guide board (e.g., an acrylic board). In some embodiments, each of the one or more BLUs 265 may include multiple segmented backlight units, each segmented backlight unit providing light sources for a specific region or zone of the active layer 240.

The polarizers 250 filter the light outputted by the one or more BLUs 265 based on the polarization of the light. The polarizers 250 may include a back polarizer 250A and a front polarizer 250B. The back polarizer 250A filters the light outputted by the one or more light sources 265 to provide a polarized light to the LC layer 260. The front polarizer 250B filters the light outputted by the LC layer 260. Since the light provided to the LC layer 260 is polarized by the back polarizer 250A, the LC layer controls an amount of filtering of the front polarizer 250B by adjusting the polarization of the light outputted by the back polarizer 250A.

The color filter 255 filters the light outputted by the LC layer 260 based on color. For instance, the one or more BLUs 265 generates white light and the color filter 255 filters the white light to output either red, green, or blue light. The color filter 255 may include a grid of red color filters, green color filters, and blue color filters. In some embodiments, the elements of the display device 220 are arranged in a different order. For example, the color filter may be placed between the one or more BLUs 265 and the back polarizer 250A, between the back polarizer 250A and the LC layer 260, or after the front polarizer 250B.

FIG. 2C illustrates an example display device 220 with a two-dimensional array of illumination elements or LC-based pixels 245, in accordance with one or more embodiments. Although the BLUs 265A-265Z are shown, there may any suitable number of BLUs (e.g., lesser or more than twenty-six light sources). In one embodiment, the display device 220 may display a plurality of frames of video content based on a global illumination where all the pixels 245 simultaneously illuminate image light for each frame. In an alternate embodiment, the display device 220 may display video content based on a segmented illumination where all pixels 245 in each segment of the display device 220 simultaneously illuminate image light for each frame of the video content. For example, each segment of the display device 220 may include at least one row of pixels 245 in the display device 220, as shown in FIG. 2C.

In the illustrative case where each segment of the display device 220 for illumination includes one row of pixels 245, the segmented illumination can be referred to as a rolling illumination. For the rolling illumination, all pixels 245 in a first row of the display device 220 simultaneously illuminate image light in a first time instant; all pixels 245 in a second row of the display device 220 simultaneously illuminate image light in a second time instant consecutive to the first time instant; all pixels 245 in a third row of the display device 220 simultaneously illuminate image light in a third time instant consecutive to the second time instant, and so on. Other orders of illumination of rows and segments of the display device 220 are also supported in the present disclosure. In yet another embodiment, the display device 220 may display video content based on a controllable illumination where all pixels 245 in a portion of the display device 220 of a controllable size (not shown in FIG. 2C) simultaneously illuminate image light for each frame of the video content. The controllable portion of the display device 220 can be rectangular, square or of some other suitable shape. In some embodiments, a size of the controllable portion of the display device 220 can be a dynamic function of a frame number.

Although the above description describes a liquid crystal display device 220, other types of display devices, such as an organic light-emitting diode (OLED), may be used.

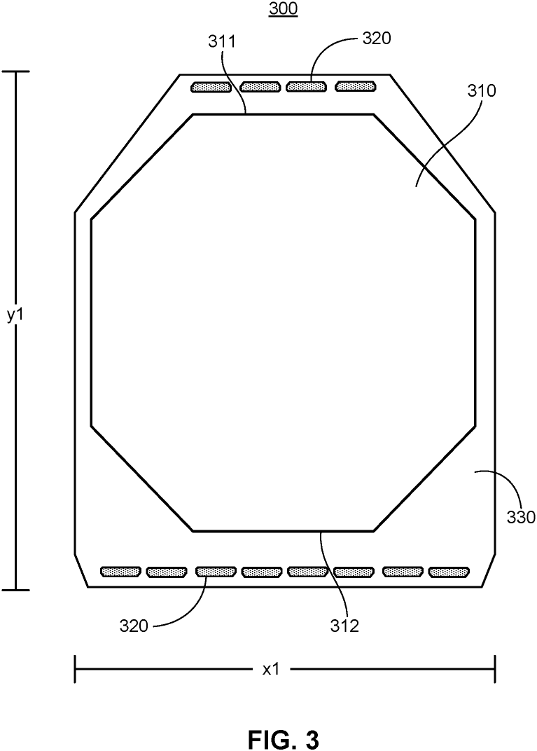

FIG. 3 shows a BLU 300 having top and bottom strips of light sources 320, according to one or more embodiments. Terms indicating position such as “top,” “center,” “bottom,” “front,” “back,” “left,” and “right” are referenced for convenience and should not require a particular orientation of the BLUs described herein. The BLU 300 includes a diffusion plate 310, the light sources 320, and a frame 330. The display area may be coupled with the diffusion plate 310 such that the light from the light sources 320 travels through the diffusion plate 310 and exits into the display area. The diffusion plate 310 may include one or more passive optical structures for diffusing and spreading light within the diffusion plate 310. These structures may be referred to as diffusion structures. In some embodiments, the BLU 300 may have a larger density of diffusion structures to increase light diffusion or brightness. Examples of diffusion structures include dot patterns, prisms, or lenticular lenses.

While diffusion plates in FIGS. 3-7 may be shaped octagonally, any suitable shape may be used for display devices (e.g., a polygon of even or odd numbered sides). In some embodiments, the shape may be equilateral. In the embodiment depicted in FIG. 3, the top side 311 and the bottom side 312 of the diffusion plate 310 are not the same length as at least one other side of the diffusion plate 310. The BLU 300 has a first dimension, x1, which may be a horizontal dimension or width, that is shorter than a second dimension, y1, which may be a vertical dimension or height. In particular, the height, y1, is longer due to the placement of the light sources 320 near the top side 311 and the bottom side 312.

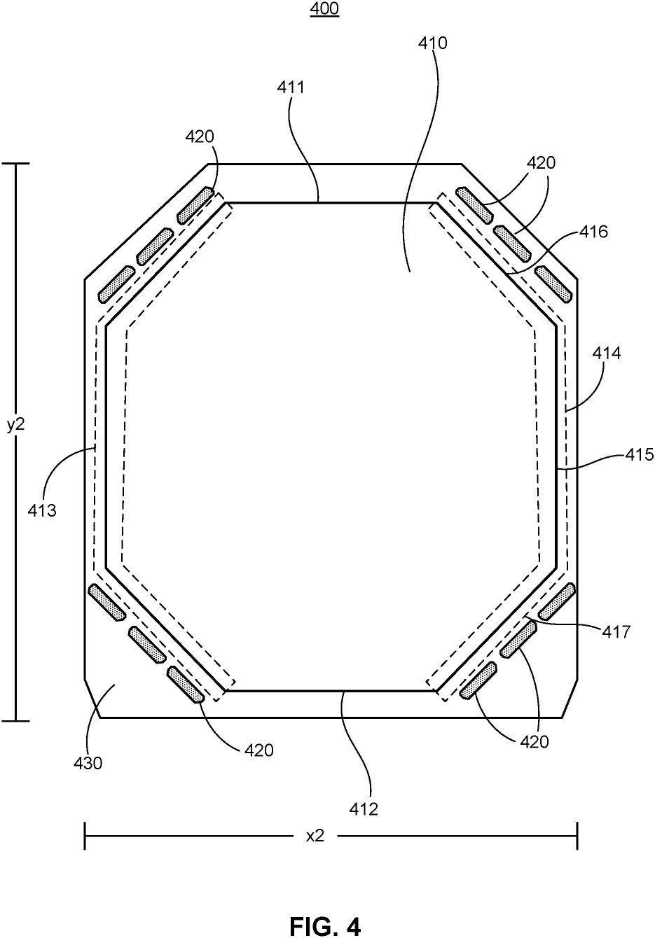

The light sources 320 and light sources referenced in FIGS. 4-7 may be light-emitting diodes. The number of light sources located near the top side 311 and the bottom side 312 may be different from the number shown in FIG. 3. In some embodiments, the number of light sources can be spaced evenly across a number of sides of the diffusion plate 310. For example, the same number of light sources can be located at the top side 311 as at the bottom side 312. As depicted in FIG. 3, a greater number of light sources is located at the bottom side 312 than at the top side 311, which can cause the bottom side 312 of the diffusion plate 310 to receive a greater amount of light than the top side 311. Thus, there may be a non-uniform distribution of light within the diffusion plate 310.

FIG. 4 shows a BLU 400 having slanted light sources 420, according to one or more embodiments. The BLU 400 includes a diffusion plate 410, light sources 420, and a frame 430. The diffusion plate 410 includes a top side 411, a bottom side 412, a left side 413, and a right side 414. The left side 413 is at an opposite side of the right side 414. Both the left side 413 and the right side 414 connect the top side 411 to the bottom side 412. The right side 414 includes a center portion 415, a first slanted portion 416, and a second slanted portion 417. The first slanted portion 416 connects the center portion 415 to the top side 411. The second slanted portion 417 connects the center portion 415 to the bottom side 412. The center portion 415 is perpendicular to the top side or the bottom side. The light sources 420 include the subsets of light sources 420a-d. A first subset of the light sources 420a is placed to emit light into the diffusion plate 410 through the first slanted portion 416 of the diffusion plate 410. A second subset of the light sources 420b is placed to emit light through the second slanted portion 417. These slanted portions may also be referred to as corners of the diffusion plate 410 (i.e., as contrasted with sides of the diffusion plate 410 such as the top side 411, the bottom side 412, or the center portion 415).

The BLU 400 has a first dimension, x2, which may be a horizontal dimension or width, and a second dimension, y2, which may be a vertical dimension or height. In particular, the height, y2, is shorter than the height, y1, of the BLU 300 due to the placement of the light sources 420 at slanted portions of the left side 413 and the right side 414. In contrast with light sources located at the top and bottom sides of the diffusion plate 410, the light sources 420 located at the slanted portions allow for portions of the vertical dimension at the top and bottom of the BLU 400 to be removed, causing y2 to be shorter than y1. This dimension reduction decreases resources (e.g., time and material) needed for production of the BLU 400 as compared with the production for the BLU 300. Because the BLU 400 may be produced with less material than the BLU 300, the BLU 400 may also be lighter than the BLU 300, which is beneficial for wearable displays (e.g., the headsets depicted in FIGS. 1A and 1B). In some embodiments, the BLU 400 may be produced without corner portions of the frame 430 (e.g., a portion of the frame near the second slanted portion 417). This may further reduce the resources needed to produce the BLU 400 and decrease the weight.

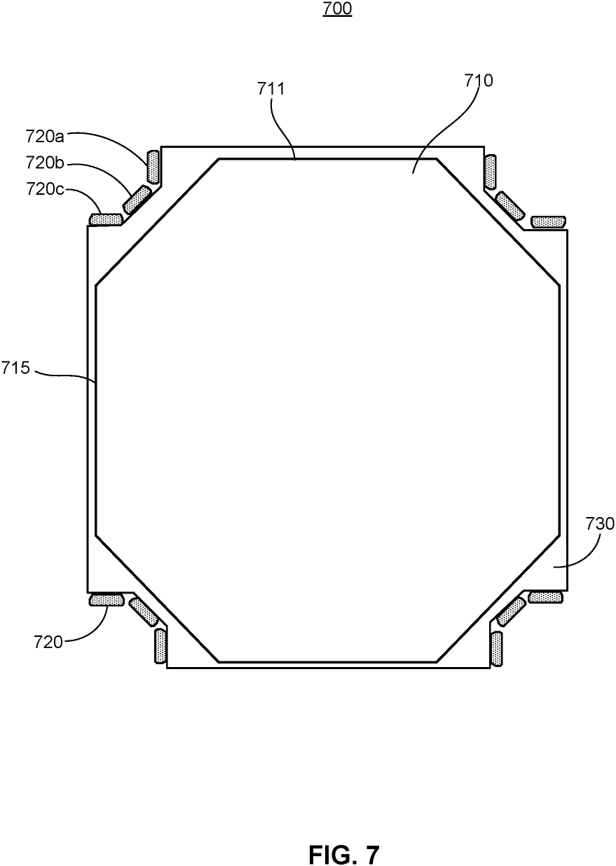

The light sources 420 of the BLU 400 may be evenly distributed across the slanted portions of the diffusion plate 410. This may improve the lighting uniformity of the BLU 400 as compared with that of the BLU 300, which may have a non-uniform lighting distribution due to the differing number of light sources 320 at the bottom side 312 of the diffusion plate 310 than at the top side 311. Although twelve light sources 420 are depicted in FIG. 4, different embodiments may have fewer or greater number of light sources. Subsets of light sources may be oriented in the same direction or in two or more directions. For example, the subset of light sources 420 at the first slanted portion 416 are depicted as oriented in the same direction, which is approximately orthogonal to the direction in which another subset of light sources 420 at the second slanted portion 417 are oriented. An embodiment shown in FIG. 7 includes subsets of light sources where the light sources in each subset are oriented in two more directions.

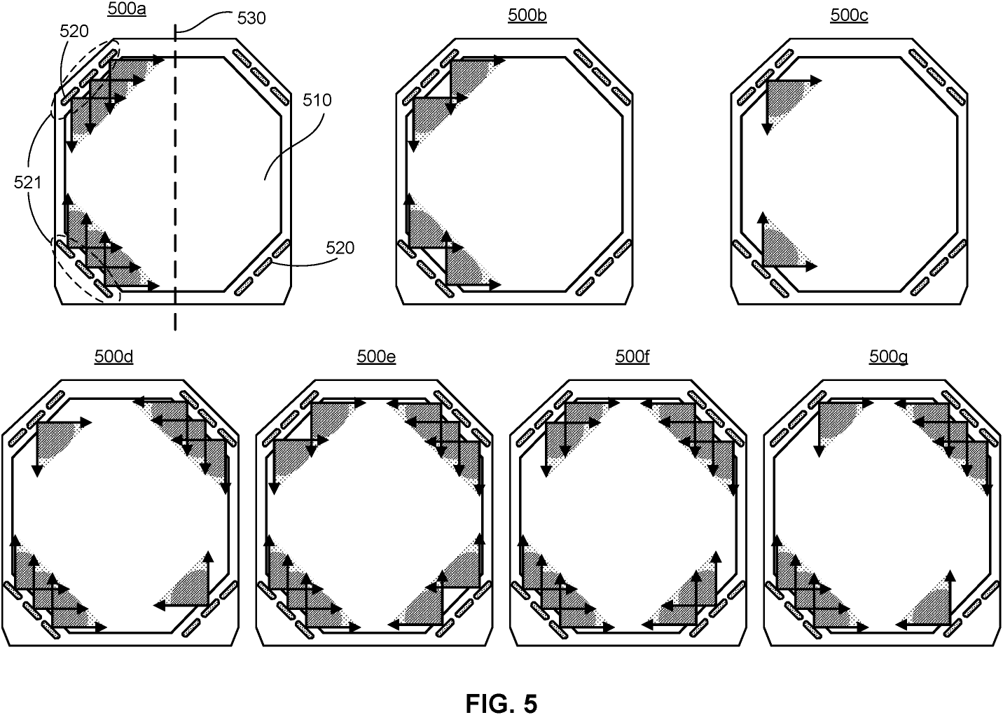

FIG. 5 shows various local dimming configurations 500a-g for light sources of a BLU 500, according to one or more embodiments. The BLU 500 includes a diffusion plate 510, light sources 520. The BLU 500 may include an LED driver (e.g., at the back side of the BLU 500 similar to the depiction in FIG. 6) that is configured to select one or more of the light sources 520 and modify an amount of light emitted by the one or more light sources. For example, selected light sources 521 of the light sources 520 are emitting light in the configuration 500a while the remaining lights are not emitting light. In this example, the LED driver may modify the amount of light emitted in a binary fashion (i.e., ON or OFF). In some embodiments, the LED driver may also adjust an amount of light emitted by the light sources 520 within a nonzero range of light intensities. The LED driver may also be referred to as a BLU driver. The LED driver may select one or more lights to dim such that the light pattern created by the light sources 520 is asymmetric about a line 530 bisecting the diffusion plate 510. The line 530 is included for reference and is not necessarily a line physically present within the BLU 500. Although seven configurations of light modification are depicted, the BLU 500 may produce more, less, or different configurations.

By modifying an amount of light emitted by the light sources 520 or selecting a subset of light sources to turn OFF, the LED driver of the BLU 500 may conserve e power and allow for local dimming. The local dimming may serve to enhance the display of media that may prioritize a high a contrast ratio between dark and light shades. The LED driver’s ability to select a subset of the light sources 520 to dim in addition to the placement of the light sources 520 at slanted portions of the sides of the diffusion plate 510 also enables increased dimming customization according to the image displayed. For example, as compared to selecting lights at only the top and bottom sides of a diffusion plate to dim, selecting lights at any or all of the slanted portions increases the different dimming patterns and coverage across the surface area of the diffusion plate 510.

FIG. 6 shows a back side 610 of a BLU 600, according to one or more embodiments. The back side 610 of the BLU 600 includes a DDIC 620, LED strip connectors 640, and an LED driver 650. The back side 610 may be oriented to face a direction away from (e.g., opposite from) a direction at which light is directed to the human eye. The DDIC 620 may have similar functions to the DDIC 230. For example, the DDIC 620 may receive a display signal from an application processor and generate control signals for controlling the BLU 600. The LED strip connectors 640 couple the LED driver 650 to light sources (e.g., LEDs) at provide instructions for adjusting the intensity at the light sources. The LED driver 650 may adjust the intensity at the light sources, where the intensity may be varied (e.g., two or more levels on a range from zero to full brightness of the light source). In some embodiments, the LED driver 650 is omitted from the BLU 600 (e.g., where adjustable intensity is not needed).

The BLU 600 may have a frame 630 that is shaped similarly or the same as the diffusion plate. For example, the diffusion plate may have an octagonal shape (e.g., as shown in FIGS. 3-5) and the frame 630 may be similarly octagonal in shape. The BLU 600 may be embodied as a chip-on-flex (COF). COF may allow the DDIC 620 to be positioned at the back side 610. The positioning of the DDIC 620 at the back side 610 may be contrasted with positioning a DDIC at an edge (e.g., bottom) of a frame. By positioning the DDIC 620 at the back side 610, the frame 630 of the BLU 600 may be smaller and lighter. For example, the material of portions of the frame 330 where a DDIC may be placed (e.g., at the bottom of the frame near the bottom side 312 and extending into the proximate corners at the bottom of the frame 330) could be removed when the DDIC 620 is no longer occupying that space and is instead at the back side 610. The presence and removal of space where a DDIC could be placed may be shown by comparison of the frame shape of the frame 330 to the frame 630, respectively.

FIG. 7 shows a BLU 700 having light sources 720 oriented in varying directions, according to one or more embodiments. The BLU 700 includes a diffusion plate 710, light sources 720, and a frame 730. Similar to the BLUs depicted in FIGS. 4 and 5, the light sources 720 are located at slanted portions of left and right sides of the diffusion plate 710. However, subsets of the set of light sources 720 are oriented such that, for at least one subset, the lights are oriented in two or more directions. For example, light sources 720a-c may be a subset of the light sources 720, and each of the light sources 720a-c are oriented in a direction different from another. Having two or more different directions in which the light sources are oriented allows for increased light coverage (e.g., within the diffusion plate 710). The direction of the light source 720a increases light exposure towards the top side 711 of the diffusion plate 710 as compared to if the light source 720a was oriented in the same direction as the light source 720b. Similarly, the light source 720c increases light exposure towards the center portion 715 of the left side of the diffusion plate 710 as compared to if the light source 720c was oriented in the same direction as the light source 720b. Thus, the positioning of light sources 720 in the BLU 700 may increase the surface area of the diffusion plate 710 which is exposed to light as compared with a BLU with light sources oriented in fewer directions.

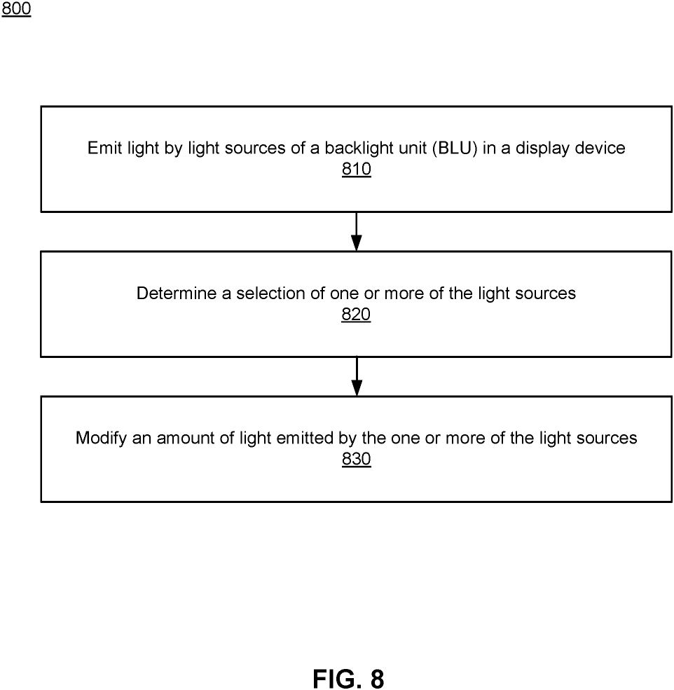

FIG. 8 is a flowchart of a process 800 for configuring local dimming through a BLU, in accordance with one or more embodiments. The process shown in FIG. 8 may be performed by components of a display device (e.g., the display device 220). Other entities may perform some or all of the steps in FIG. 8 in other embodiments. Embodiments may include different and/or additional steps, or perform the steps in different orders.

A display device emits 810 light by light sources of a BLU. For example, a headset may emit 810 light by a BLU when displaying video or images to a user. The LEDs of the BLU are sources of light directed towards various pixels for displaying the video or images. In some embodiments, the display device may emit 810 light through light sources of multiple BLUs. One or more drivers of the display device (e.g., DDIC or LED driver) may determine the manner through which light is emitted 810. The one or more drivers may also perform other steps of the method 800.

The display device determines 820 a selection of one or more of the light sources. The display device may determine 820 the selection based on the image or video displayed (e.g., based on image contrast), power saving conditions (e.g., a period of idle time before automatically dimming the lights), user environment (e.g., an intensity of ambient light may cause the display device to increase or decrease the intensity emitted by the lights), manual instructions (e.g., user requests to adjust the contrast of displayed images), any suitable context parameter for adjusting the light intensity of a BLU light source, or a combination thereof.

The display device modifies 830 an amount of light emitted by the one or more of the light sources. The display device may turn OFF a light source, turn ON a light source, or lower or increase an intensity emitted from the one or more light sources. For example, the display device may increase the intensity emitted by one or more light sources in response to determining that the ambient light intensity is above a threshold value. In another example, the display device may turn OFF a subset of light sources in response to determining that an image to be displayed or currently displayed has a contrast level that may be achieved faster when the subset of light sources located near a darker portion of the image are turned OFF.

FIG. 9 is a system 900 that includes a headset 905, in accordance with one or more embodiments. In some embodiments, the headset 905 may be the headset 100 of FIG. 1A or the headset 105 of FIG. 1B. The system 900 may operate in an artificial reality environment (e.g., a virtual reality environment, an augmented reality environment, a mixed reality environment, or some combination thereof). The system 900 shown by FIG. 9 includes the headset 905, an input/output (I/O) interface 910 that is coupled to a console 915, the network 920, and the mapping server 925. While FIG. 9 shows an example system 900 including one headset 905 and one I/O interface 910, in other embodiments any number of these components may be included in the system 900. For example, there may be multiple headsets each having an associated I/O interface 910, with each headset and I/O interface 910 communicating with the console 915. In alternative configurations, different and/or additional components may be included in the system 900. Additionally, functionality described in conjunction with one or more of the components shown in FIG. 9 may be distributed among the components in a different manner than described in conjunction with FIG. 9 in some embodiments. For example, some or all of the functionality of the console 915 may be provided by the headset 905.

The headset 905 includes the display assembly 930, an optics block 935, one or more position sensors 940, and the DCA 945. Some embodiments of headset 905 have different components than those described in conjunction with FIG. 9. Additionally, the functionality provided by various components described in conjunction with FIG. 9 may be differently distributed among the components of the headset 905 in other embodiments, or be captured in separate assemblies remote from the headset 905.

The display assembly 930 displays content to the user in accordance with data received from the console 915. The display assembly 930 displays the content using one or more display elements (e.g., the display elements 120). A display element may be, e.g., an electronic display. In various embodiments, the display assembly 930 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 935.

The optics block 935 may magnify image light received from the electronic display, corrects optical errors associated with the image light, and presents the corrected image light to one or both eyeboxes of the headset 905. In various embodiments, the optics block 935 includes one or more optical elements. Example optical elements included in the optics block 935 include: an aperture, a Fresnel lens, a convex lens, a concave lens, a filter, a reflecting surface, or any other suitable optical element that affects image light. Moreover, the optics block 935 may include combinations of different optical elements. In some embodiments, one or more of the optical elements in the optics block 935 may have one or more coatings, such as partially reflective or anti-reflective coatings.

Magnification and focusing of the image light by the optics block 935 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user’s field of view. Additionally, in some embodiments, the amount of magnification may be adjusted by adding or removing optical elements.

In some embodiments, the optics block 935 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 935 corrects the distortion when it receives image light from the electronic display generated based on the content.

The position sensor 940 is an electronic device that generates data indicating a position of the headset 905. The position sensor 940 generates one or more measurement signals in response to motion of the headset 905. The position sensor 190 is an embodiment of the position sensor 940. Examples of a position sensor 940 include: one or more IMUs, one or more accelerometers, one or more gyroscopes, one or more magnetometers, another suitable type of sensor that detects motion, or some combination thereof. The position sensor 940 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 905 from the sampled data. For example, the IMU integrates the measurement signals received from the accelerometers over time to estimate a velocity vector and integrates the velocity vector over time to determine an estimated position of a reference point on the headset 905. The reference point is a point that may be used to describe the position of the headset 905. While the reference point may generally be defined as a point in space, however, in practice the reference point is defined as a point within the headset 905.

The DCA 945 generates depth information for a portion of the local area. The DCA includes one or more imaging devices and a DCA controller. The DCA 945 may also include an illuminator. Operation and structure of the DCA 945 is described above with regard to FIG. 1A.

The audio system 950 provides audio content to a user of the headset 905. The audio system 950 is substantially the same as the audio system described above with reference to FIG. 1. The audio system 950 may comprise one or acoustic sensors, one or more transducers, and an audio controller. The audio system 950 may provide spatialized audio content to the user. In some embodiments, the audio system 950 may request acoustic parameters from the mapping server 925 over the network 920. The acoustic parameters describe one or more acoustic properties (e.g., room impulse response, a reverberation time, a reverberation level, etc.) of the local area. The audio system 950 may provide information describing at least a portion of the local area from e.g., the DCA 945 and/or location information for the headset 905 from the position sensor 940. The audio system 950 may generate one or more sound filters using one or more of the acoustic parameters received from the mapping server 925, and use the sound filters to provide audio content to the user.

The I/O interface 910 is a device that allows a user to send action requests and receive responses from the console 915. An action request is a request to perform a particular action. For example, an action request may be an instruction to start or end capture of image or video data, or an instruction to perform a particular action within an application. The I/O interface 910 may include one or more input devices. Example input devices include: a keyboard, a mouse, a game controller, or any other suitable device for receiving action requests and communicating the action requests to the console 915. An action request received by the I/O interface 910 is communicated to the console 915, which performs an action corresponding to the action request. In some embodiments, the I/O interface 910 includes an IMU that captures calibration data indicating an estimated position of the I/O interface 910 relative to an initial position of the I/O interface 910. In some embodiments, the I/O interface 910 may provide haptic feedback to the user in accordance with instructions received from the console 915. For example, haptic feedback is provided when an action request is received, or the console 915 communicates instructions to the I/O interface 910 causing the I/O interface 910 to generate haptic feedback when the console 915 performs an action.

The console 915 provides content to the headset 905 for processing in accordance with information received from one or more of: the DCA 945, the headset 905, and the I/O interface 910. In the example shown in FIG. 9, the console 915 includes an application store 955, a tracking module 960, and an engine 965. Some embodiments of the console 915 have different modules or components than those described in conjunction with FIG. 9. Similarly, the functions further described below may be distributed among components of the console 915 in a different manner than described in conjunction with FIG. 9. In some embodiments, the functionality discussed herein with respect to the console 915 may be implemented in the headset 905, or a remote system.

The application store 955 stores one or more applications for execution by the console 915. An application is a group of instructions, that when executed by a processor, generates content for presentation to the user. Content generated by an application may be in response to inputs received from the user via movement of the headset 905 or the I/O interface 910. Examples of applications include: gaming applications, conferencing applications, video playback applications, or other suitable applications.

The tracking module 960 tracks movements of the headset 905 or of the I/O interface 910 using information from the DCA 945, the one or more position sensors 940, or some combination thereof. For example, the tracking module 960 determines a position of a reference point of the headset 905 in a mapping of a local area based on information from the headset 905. The tracking module 960 may also determine positions of an object or virtual object. Additionally, in some embodiments, the tracking module 960 may use portions of data indicating a position of the headset 905 from the position sensor 940 as well as representations of the local area from the DCA 945 to predict a future location of the headset 905. The tracking module 960 provides the estimated or predicted future position of the headset 905 or the I/O interface 910 to the engine 965.

The engine 965 executes applications and receives position information, acceleration information, velocity information, predicted future positions, or some combination thereof, of the headset 905 from the tracking module 960. Based on the received information, the engine 965 determines content to provide to the headset 905 for presentation to the user. For example, if the received information indicates that the user has looked to the left, the engine 965 generates content for the headset 905 that mirrors the user’s movement in a virtual local area or in a local area augmenting the local area with additional content. Additionally, the engine 965 performs an action within an application executing on the console 915 in response to an action request received from the I/O interface 910 and provides feedback to the user that the action was performed. The provided feedback may be visual or audible feedback via the headset 905 or haptic feedback via the I/O interface 910.

The network 920 couples the headset 905 and/or the console 915 to the mapping server 925. The network 920 may include any combination of local area and/or wide area networks using both wireless and/or wired communication systems. For example, the network 920 may include the Internet, as well as mobile telephone networks. In one embodiment, the network 920 uses standard communications technologies and/or protocols. Hence, the network 920 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 920 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 920 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 925 may include a database that stores a virtual model describing a plurality of spaces, wherein one location in the virtual model corresponds to a current configuration of a local area of the headset 905. The mapping server 925 receives, from the headset 905 via the network 920, information describing at least a portion of the local area and/or location information for the local area. The user may adjust privacy settings to allow or prevent the headset 905 from transmitting information to the mapping server 925. The mapping server 925 determines, based on the received information and/or location information, a location in the virtual model that is associated with the local area of the headset 905. The mapping server 925 determines (e.g., retrieves) one or more acoustic parameters associated with the local area, based in part on the determined location in the virtual model and any acoustic parameters associated with the determined location. The mapping server 925 may transmit the location of the local area and any values of acoustic parameters associated with the local area to the headset 905.

One or more components of system 900 may contain a privacy module that stores one or more privacy settings for user data elements. The user data elements describe the user or the headset 905. For example, the user data elements may describe a physical characteristic of the user, an action performed by the user, a location of the user of the headset 905, a location of the headset 905, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 900 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A display device comprising:
a display area having a plurality of pixels; and
a backlight unit (BLU) at a back side of the display area and configured to direct light to the plurality of pixels, the BLU comprising:
a diffusion plate with a top side, a bottom side, a right side connecting the top side and the bottom side, and a left side at an opposite side of the right side and connecting the top side and the bottom side, and
a plurality of light sources located at one or more of the left and right sides of the diffusion plate to emit light into the diffusion plate.

2. The display device of claim 1, wherein the right side has a center portion perpendicular to the top side or the bottom side, a first slanted portion connecting the center portion and the top side, wherein a first subset of the plurality of light sources is placed to emit light into the first slanted portion.

3. The display device of claim 2, wherein the right side further has a second slanted portion connecting the center portion and the bottom side, wherein a second subset of the plurality of light sources is placed to emit light into the second slanted portion.

4. The display device of claim 2, wherein the first subset of the plurality of light sources is oriented in two or more directions.

5. The display device of claim 1, further comprising a display driver IC (DDIC) located at a back side of the BLU, the back side facing away from the display area.

6. The display device of claim 1, further comprising a BLU driver configured to modify an amount of light emitted by one or more light sources of the plurality of light sources.

7. The display device of claim 6, wherein the positions of the one or more light sources are asymmetric about a line bisecting the diffusion plate.

8. The display device of claim 1, wherein the plurality of light sources are light-emitting diodes (LEDs).

9. The display device of claim 1, wherein the same number of light sources are located at the first slanted portion and the second slanted portion.

10. The display device of claim 1, wherein the display area is included within a head mounted display (HMD).

11. An HMD configured to be worn on a user’s head, the HMD comprising:
a body;
a strap configured to secure the body to the user’s head; and
a display device contained in the body, the display device comprising:
a display area having a plurality of pixels; and
a backlight unit (BLU) at a back side of the display area and configured to direct light to the plurality of pixels, the BLU comprising:
a diffusion plate with a top side, a bottom side, a right side connecting the top side and the bottom side, and a left side at an opposite side of the right side and connecting the top side and the bottom side, and
a plurality of light sources located at one or more of the left and right sides of the diffusion plate to emit light into the diffusion plate.

12. The HMD of claim 11, wherein the right side has a center portion perpendicular to the top side or the bottom side, a first slanted portion connecting the center portion and the top side, wherein a first subset of the plurality of light sources is placed to emit light into the first slanted portion.

13. The HMD of claim 12, wherein the right side further has a second slanted portion connecting the center portion and the bottom side, wherein a second subset of the plurality of light sources is placed to emit light into the second slanted portion.

14. The HMD of claim 11, wherein the display device further comprises a BLU driver located at a back side of the display area, the BLU driver configured to modify an amount of light emitted by one or more light sources of the plurality of light sources.

15. The HMD of claim 15, wherein the BLU driver is further configured to determine a selection of the one or more light sources, wherein the selection is asymmetric about a line bisecting the display area.

16. A method comprising:
emitting light by a plurality of light sources of a backlight unit (BLU) in a display device, the display device comprising:
a display area having a plurality of pixels, and
the BLU at a back side of the display area and configured to direct light to the plurality of pixels, the BLU comprising:
a diffusion plate with a top side, a bottom side, a right side connecting the top side and the bottom side, and a left side at an opposite side of the right side and connecting the top side and the bottom side, and
a plurality of light sources located at one or more of the left and right sides of the diffusion plate to emit light into the diffusion plate;
determining a selection of one or more of the plurality of light sources; and
modifying an amount of light emitted by the one or more of the plurality of light sources.

17. The method of claim 16, wherein the right side has a center portion perpendicular to the top side or the bottom side, a first slanted portion connecting the center portion and the top side, wherein a first subset of the plurality of light sources is placed to emit light into the first slanted portion.

18. The method of claim 16, wherein the right side further has a second slanted portion connecting the center portion and the bottom side, wherein a second subset of the plurality of light sources is placed to emit light into the second slanted portion.

19. The method of claim 16, wherein the selection is asymmetric about a line bisecting the display area.

20. The method of claim 16, wherein the same number of light sources are located at the first slanted portion and the second slanted portion.
